(19) United States
(12) Patent Application Publication
(10) Pub. No.: US 2006/0111912 A1
(43) Pub. Date: May 25, 2006

(54) Audio analysis of voice communications over data networks to prevent unauthorized usage

(76) Inventors: Andrew D. Christian, Lincoln, MA (US); Brian L. Avery, Lexington, MA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/993,453

(22) Filed: Nov. 19, 2004

(51) Int. Cl. G10L 11/00

(52) U.S. Cl. 704/273

(57) ABSTRACT

An audio data security method and apparatus of the present invention verifies a subject audio communication stream. Verification is by a valid audio encoding detection module, a human speech frequency detection module, a human speech pattern detection module, a music frequency detection module, a human speech prosody detection module, a white noise detection module, and an environmental noise detection module.

### BACKGROUND OF THE INVENTION

Today various personnel of large companies or in corporate settings use computers. Many of these people like to have access to computer services outside of the corporate setting (e.g., web sites, email, and chat rooms). To enable outside access, the corporate information technology (IT) staff sets up firewalls and bastion hosts between the internal and external networks that prevent unauthorized use or entry, yet still allow employees access to useful network resources.

For example, company ABC's IT policy can be approximated as: (a) internal machines are allowed to directly initiate TCP connections to external machines on a specific subset of TCP ports, (b) internal machines may be allowed to use approved proxy hosts for accessing a more general set of external services (e.g., web access), (c) external machines are allowed to tunnel into the company's network only if they have provided appropriate authentication and are running IT-approved software configurations, and (d) email from external machines is routed through appropriate bastion hosts and scanned for viruses. It is important to note that the only unauthenticated form of communication that is initiated by an external party is email, accordingly email is carefully checked before being delivered to employees to ensure security of ABC's (the company) network.

Now consider the problem with respect to voice-over-internet protocol (VOIP). The VOIP telephone or VOIP-enabled computer is on an employee's desk and belongs to the internal corporate network. However, to be useful as a telephone, this same device should be able to receive VOIP telephone calls from people outside of the corporation (e.g., external call). Typically this functionality is implemented by placing a bastion host at the firewall that receives incoming telephone calls and forwards them to the appropriate internal VOIP equipment.

An incoming VOIP telephone call consists of two logical parts: a signaling channel and a bi-directional voice (audio communication) data stream. Current bastion host technology processes the signaling channel and verifies that it appears to be an honest telephone call before passing it on to the end client. However, the voice or media data stream is forwarded without any further security measures. An example of this is, no determination is made to ensure that the data/media stream is in fact what it purports to be, i.e., an audio telephone call or voice data.

The natural concern of IT staffs in general is that the audio communication stream could be used for something other than audio data. It is plausible that an individual outside of the corporation could send a corrupted media stream to an internal VOIP client and attempt to exploit buffer-overrun attacks or other known problems with internal clients. For example, some VOIP telephones or soft telephones (software operating as telephones) have been known to reboot upon receiving a bad data stream. In addition, many soft telephones have known problems that can result in unintended actions on a client machine, such as running out of memory or greatly slowing down the machine. Given these known problems, it is not implausible that someone could inject a virus or remotely gain access to an improperly secured client machine using a data stream.

Current firewall and bastion host implementations act as gatekeepers, but do not modify or validate the audio communication stream, so there are no safeguards once the call has been set up and the media stream established.

### SUMMARY OF THE INVENTION

There is a need for solutions that implement audio communication security by verifying the subject data streams. The present invention provides such a bi-directional audio data security system and method. In particular, the present invention provides an analysis of audio communications over data networks and performs a particular function if the data is found to be invalid.

In one embodiment of the present invention, the audio data security system includes an audio communication stream and an audio validator that is responsive to the audio communication stream, the audio validator analyzing the audio communication stream to determine if the communication stream is valid. The audio validator can include a data encoding analyzer. The data encoding analyzer can analyze the audio communication stream for a valid digital audio encoding format. The audio validator can include a signal analyzer. The signal analyzer can analyze the audio communication stream for valid speech content and/or valid music content and/or valid environmental noise. The signal analyzer can analyze the audio communication stream for non-environmental noise. The signal analyzer can include at least one member selected from the group consisting of a human speech frequency detection module, a human speech pattern detection module, a music frequency detection module, a human speech prosody detection module, a white noise detection module, and an environmental noise detection module.

In another embodiment, the audio validator can include a supervisor module which combines scores from at least two modules. The supervisor module, based on the combined score, alerts a member of the information technology staff, drops a connection, logs a source and type of connection, and or blocks future connections from a source.

In another embodiment, the present invention can include a data decoder. The data decoder can decode the audio communication stream into a common audio stream format before the audio stream is analyzed by the signal analyzer.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a schematic view of a VOIP network employing audio data security of the present invention;

FIG. 2 is a schematic view of a VOIP network with a firewall directing the subject audio communication stream, the network employing an embodiment of the present invention audio data security;

FIG. 3 is a flow chart of the present invention audio data security process which includes verification of a subject audio communication stream;

FIG. 4 is a block diagram of a data decoder, data encoding analyzer, and signal analyzer of the present invention; and

FIG. 5 is a block diagram of a data decoder, data encoding analyzer and signal analyzer of another embodiment of the present invention which includes a supervisor module which takes action on the analysis of the audio communication stream.

### DETAILED DESCRIPTION OF THE INVENTION

The present invention provides a low-cost solution that monitors audio channels carrying audio communication streams over a data network. The present invention determines whether an audio communication stream is a valid data stream and reports and/or dumps invalid data streams. For example, during a VOIP telephone conversation an internal user on the network may try to send internal data to an external source. During the course of the conversation, the subject invention would determine that a non-valid audio communication stream is being transmitted over the data network and/or report the non-valid audio communication stream and/or drop the connection.

By way of general overview, one embodiment of the present invention includes a computer having one or more network interfaces (e.g., high speed) and an audio validator. The audio validator analyzes the audio communication streams for valid human speech, music, and environmental noise. The audio validator also analyzes the audio communication streams for audio signals that would not be normally generated by human speech, music, or environmental noise, such as white noise. The audio validator can include a data encoding analyzer and/or a signal analyzer.

The data encoding analyzer verifies that the format of the encoded audio communication stream matches with the encoding format specified when the audio communication stream was established.

The signal analyzer can include one or more of the following analysis modules: (1) a human speech frequency detection module; (2) a human speech pattern detection module; (3) a music frequency detection module; (4) a human speech prosody detection module; (5) a white noise detection module; (6) and an environmental noise detection module. It should be known that other detection modules known in the art may also be implemented. The signal analyzer analysis modules may work directly on the encoded audio communication stream, or the signal analyzer may optionally decode the audio communication stream to a common format and the signal analyzer analysis modules may work on the common format.

The audio validator may also include a supervisor module which combines scores from the data encoding analyzer and the signal analyzer analysis modules and takes appropriate action. For example, the supervisor module may alert a member of the informational technology staff, drop the connection, log the source and type of connection, and/or block connections from the source in the future.

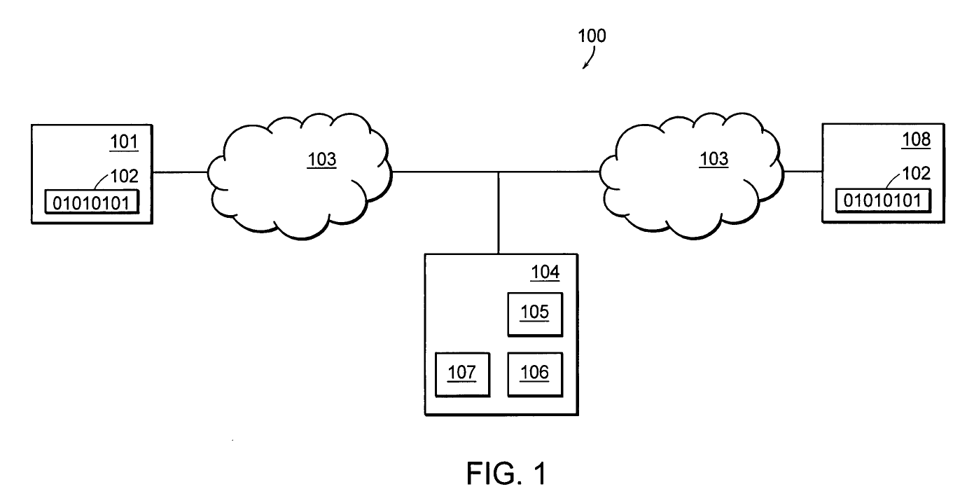

FIG. 1 is a schematic view of a VOIP network employing audio data security of the present invention. In FIG. 1, a VOIP network 100 carries a subject audio communication stream 102 setup between (through a routing network 103) a VOIP device 101 and a VOIP device 108. The audio communication stream 102 is indicative of a voice communication (e.g., incoming or outgoing phone call). The audio communication stream 102 is monitored by a audio validator 104 to determine if the audio communication stream 102 is valid. In one embodiment, the audio communication stream 102 is sent to or received by (through a routing network 103) the audio validator 104 using a high-speed network interface (not shown). Similarly, in another embodiment of the present invention, the audio validator 104 may have more than one high-speed network interface. It should be understood that the network 100 can be a bi-directional network or a unidirectional network.

The audio validator 104 can include a data decoder 105, a signal analyzer 106, and a data encoding analyzer 107. The data decoder 105 is responsive to the received audio communication stream 102 and decodes the audio communication stream 102 to a common format. After decoding the audio communication stream 102, the signal analyzer 106 determines if the audio communication stream 102 is what it purports itself to be. The data encoding analyzer 107 determines if the audio communication data encoding is what it purports itself to be. The VOIP device 108 can be a VOIP telephone and/or VOIP enabled computer system. The routing network 103 can be the internet, intranet, or other known routing network. Although the audio communication stream 102 is shown to be decoded prior to being analyzed, the audio communication stream 102 can be analyzed without being prior decoded.

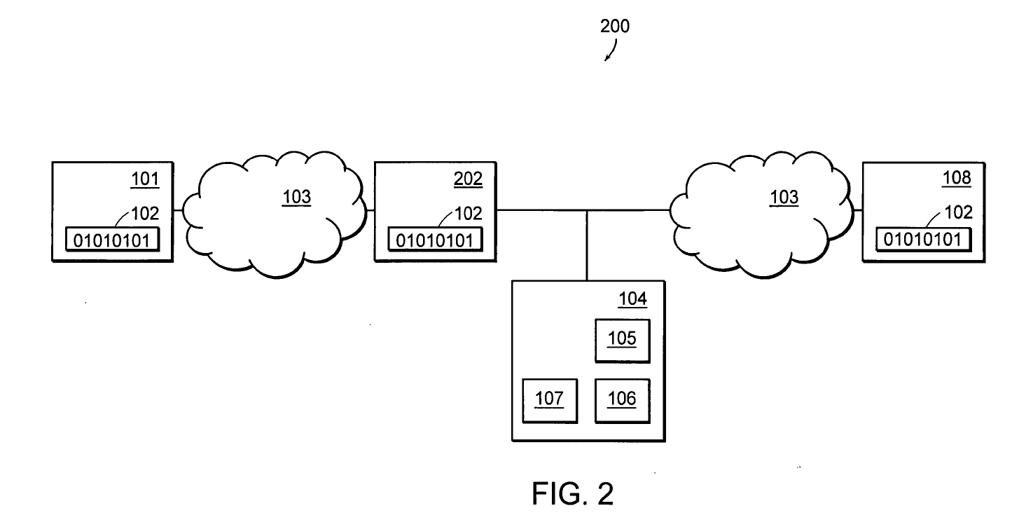

FIG. 2 is a diagram of a VOIP network 200 employing the audio validator 104 of the present invention and using a firewall 202 to the direct audio communication stream 102. In one embodiment, the firewall 202 initially receives the audio communication stream 102 (through the routing network 103) and then directs the audio communication stream 102 to the appropriate destination in the same way as described for FIG. 1 and directs the audio communication stream 102 to the audio validator 104. The audio validator 104 monitors the audio communication stream as described with reference to FIG. 1.

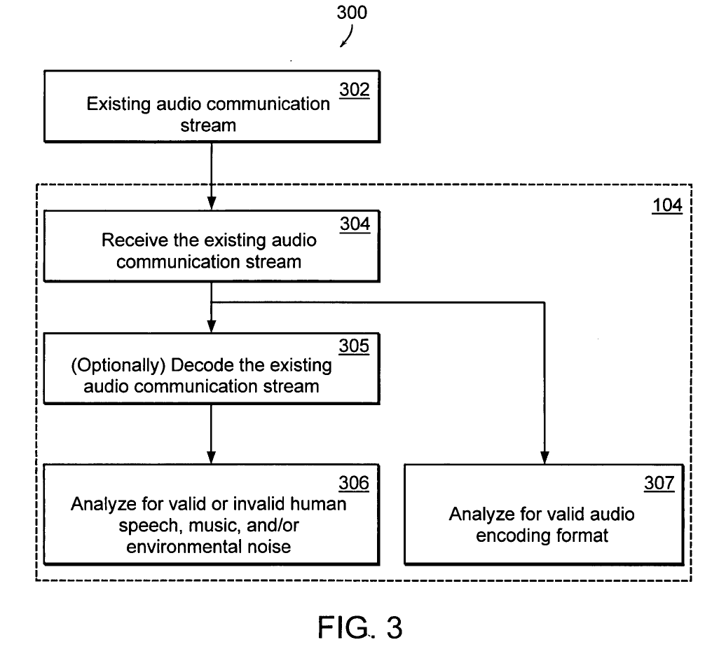

FIG. 3 is a flow diagram 300 of the audio validator 104 (of FIG. 1) process of verifying a audio communication stream 102. At step 302, an audio communication stream 102 exists on a network. The audio communication stream 102 is received by the audio validator 104 in step 304. Upon receiving the audio communication stream 102, the data encoding analyzer 107 then determines if the audio communication stream 102 is in the format agreed upon when the audio communication stream was established (step 307). Upon receiving the audio communication stream 102, the data decoder 105 can optionally decode the audio communication stream 102 to a common format (step 305). The signal analyzer 106 then determines if the audio communication stream 102 is what it purports itself to be (step 306).

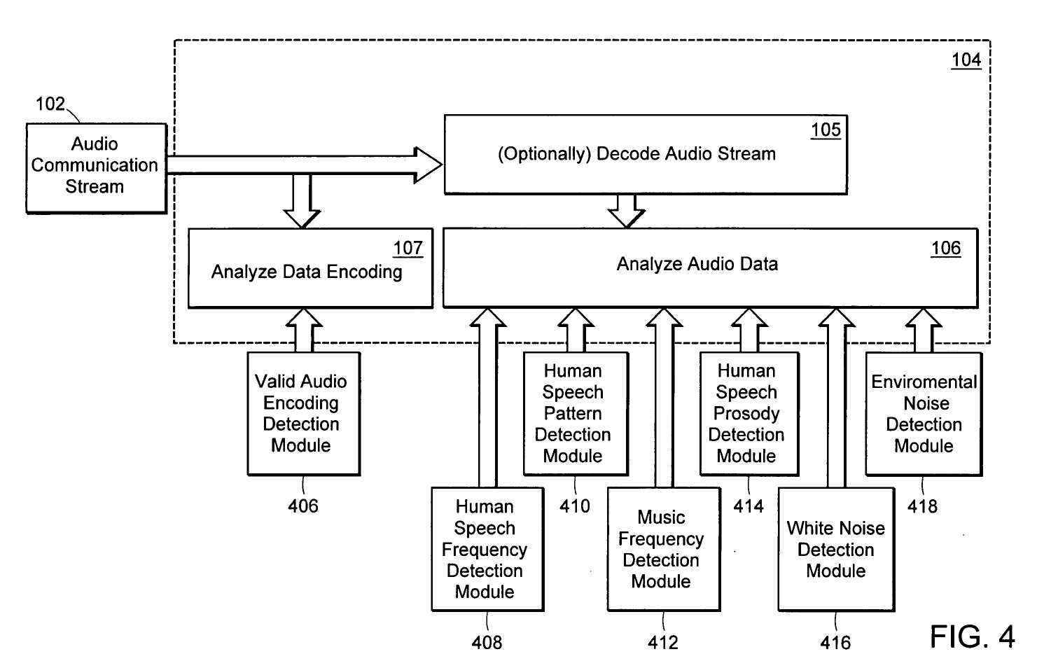

Referring to FIGS. 1 and 2, an audio validator 104 employs an optional data decoder 105, a data encoding analyzer 107, and a signal analyzer 106 to analyze an audio communication stream 102 of human speech and/or music content as described above. An expanded view of the data encoding analyzer 107 and signal analyzer 106 is shown in FIG. 4. In one embodiment, as illustrated in FIG. 4, the signal analyzer 106 and data encoding analyzer 107 includes various analysis modules for verifying the audio communication stream 102. Examples include, but are not limited to: (1) a valid audio encoding detection module 406 (checks for the correct format of audio stream); (2) a human speech frequency detection module 408 (checks for expected fundamental frequency and overtones); (3) a human speech pattern detection module 410 (checks for temporal sequencing of human utterances and pauses) ; (4) a music frequency detection module 412 (checks for tones and rhythms); (5) a human speech prosody detection module 414 (checks for tonal rise and fall of human speech); (6) a white noise detection module 416 (checks for uncorrelated noise typically found in transmission of raw digital data); (7) and an environmental noise detection module 418 (checks for noise typically found in the recording of background audio). Known techniques for implementing these examples are employed. Any combination of the foregoing and similar examples may be used by signal analyzer 106 and data encoding analyzer 107.

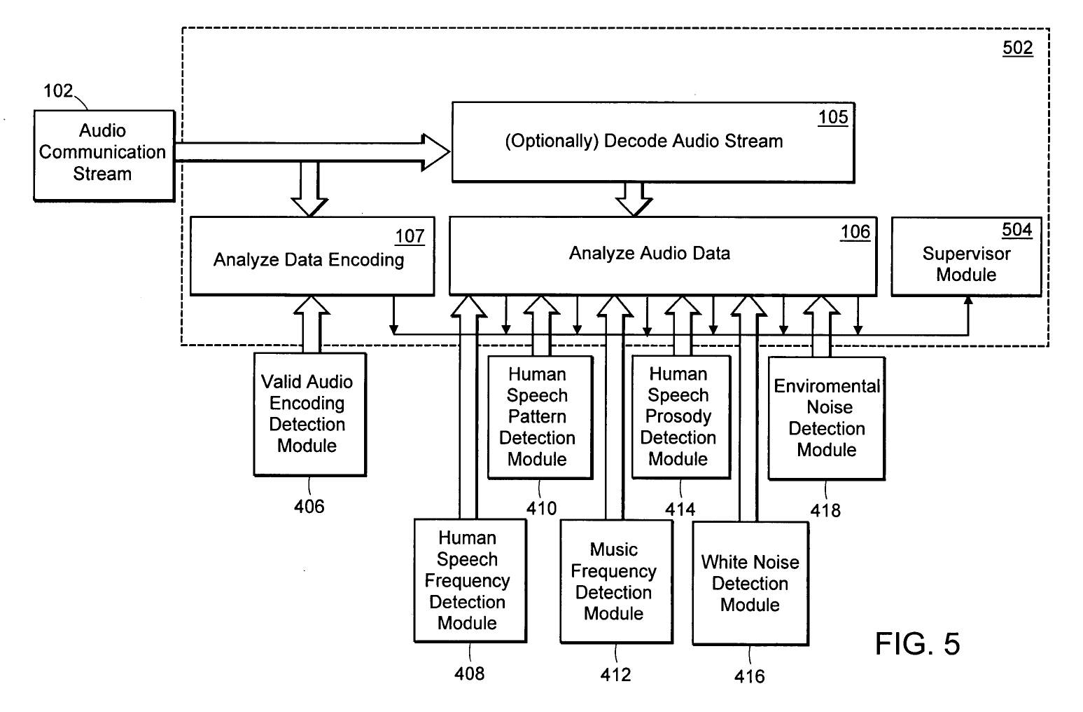

FIG. 5 shows an expanded view of an audio validator 502 that may include a supervisor module 504. The audio validator 502 for the most part is similar to the audio validator 104 of FIG. 4. However, after the data encoding analyzer 107 and signal analyzer 106 analyze the audio communication stream 102, the supervisor module 504 combines scores from the aforementioned analysis modules and takes appropriate action. Examples may include, but are not limited too: (1) alerting a member of the informational technology staff; (2) dropping the connection; (3) logging the source and type of connection; (4) and/or blocking connections from the source in the future. The audio communication stream 102 is setup between an initiation address and a destination address for voice/audio communication connection as described and shown in FIGS. 1 and 2.

Referring to FIGS. 4 and 5, the valid audio encoding detection module 406 verifies that the format of the encoded audio communication stream matches with the encoding format specified when the audio communication stream was established. For example, one version of mu-law audio encoding stores audio samples in signed 8-bit units. In a valid audio stream, the average bias of the mu-law encoded audio stream will be zero. One possible implementation of the valid audio encoding detection module 406 for signed 8-bit mu-law encoded audio measures the average bias of the audio stream and verifies that it is approximately zero.

Referring to FIGS. 4 and 5, the human speech frequency detection module 408 verifies that the frequency content of the audio communication stream is in the range of normal human speech. For example, the sound generated by the vibration of vocal cords is composed of a fundamental frequency and many harmonic overtones at successively higher frequencies. The frequency band of interest in human voice is generally between 60 and 7,500 Hz. In an adult male, for example, the first four major frequencies are close to 500, 1500, 2500, and 3500 Hz respectively. One possible implementation of the human speech frequency detection module 408 looks for a fundamental frequency in the normal range for human males and females as well as appropriately scaled harmonic frequencies.

Referring to FIGS. 4 and 5, the human speech pattern detection module 410 verifies that the audio communication stream consists of a series of utterances and pauses. For example, normal human speech consists of utterances composed of syllables with inter- and intra-utterance pauses. Moreover, normal human speech contains longer pauses between groupings of utterances such as sentences or complete phrases. One possible implementation of the human speech pattern detection module 410 records the frequency of pauses of each of the typical durations in the voice stream and compares this record against average human speech patterns.

Referring to FIGS. 4 and 5, the music frequency detection module 412 verifies that the frequency content of the audio signal is in the range of normal human music. For example, instrumental music normally contains fundamental frequencies between 0.5 and 4 Hz which corresponds to the primary meter of the music (the beat of the music). Wind and string musical instruments generate tones consisting of a fundamental frequency and a series of harmonic overtones. One possible implementation of the music frequency detection module 412 looks for the existence of fundamental frequencies and appropriate harmonics in the audio stream in the range of normal music meters and normal instrument frequencies.

Referring to FIGS. 4 and 5, the human speech prosody detection module 414 verifies that the frequency content of the audio signal varies over the course of a series of utterances within the normal range of human speech. For example, typical human speech in English has a rising tone at the end of a question. One possible implementation of the human speech prosody detection module 414 tracks the fundamental frequency of the utterances and verifies that it changes over time in a manner consistent with normal human speech.

Referring to FIGS. 4 and 5, the white noise detection module 416 verifies that the spectral energy of the audio signal is flat across all measurable frequency bands. For example, the transmission of non-audio data typically exhibits white noise characteristics. One possible implementation of the white noise detection module 416 measures the auto-correlation of the audio signal where a low auto-correlation indicates a probable white noise signal.

Referring to FIGS. 4 and 5, the environmental noise detection module 418 verifies that the spectral energy of the audio signal is consistent with normal environmental noise sources. For example, between utterances in normal human speech, the audio channel will carry a certain amount of ambient environmental noise. Most environmental noise has the characteristic that the energy in each frequency band decreases with increasing frequency. One possible implementation of the environmental noise detection module 418 measures the energy content across all frequency bands between utterances and verifies that the energy content in each frequency band decreases with increasing frequency.

It will be apparent to those of ordinary skill in the art that methods involved in the present invention may be embodied in a computer program product that includes a computer readable and usable medium. For example, such a computer usable medium may consist of a read only memory device, such as a CD ROM disk or conventional ROM devices, or a random access memory, such as a hard drive device or a computer diskette, having a computer readable program code implementing steps 304, 305, 306, and 307 of FIG. 3 stored thereon.

While this invention has been particularly shown and described with references to preferred embodiments thereof, it will be understood by those skilled in the art that various changes in form and details may be made therein without departing from the scope of the invention encompassed by the appended claims.

What is claimed is:

1. An audio data security system, comprising:
an audio communication stream; and
an audio validator responsive to the audio communication stream, the audio validator analyzing the audio communication stream to determine if the communication stream is valid.

2. The audio data security system of claim 1, wherein the audio validator includes at least one member selected from the group consisting of a signal analyzer and a data encoding analyzer.

3. The audio data security system of claim 2, wherein the signal analyzer analyzes the audio communication stream for valid speech content, valid music content or valid speech content and valid music content.

4. The audio data security system of claim 2, wherein the audio validator further includes a data decoder.

5. The audio data security system of claim 3, wherein the data decoder decodes the audio communication stream into a common audio stream format.

6. The audio data security system of claim 5, wherein the signal analyzer analyzes the audio communication stream for valid speech content, valid music content or valid speech content and valid music content.

7. The audio data security system of claim 2, wherein the signal analyzer and data encoding analyzer includes at least one member selected from the group consisting of a valid audio encoding detection module, a human speech frequency detection module, a human speech pattern detection module, a music frequency detection module, a human speech prosody detection module, a white noise detection module, and an environmental noise detection module.

8. The audio data security system of claim 7, wherein the audio validator includes a supervisor module which combines scores from at least two modules.

9. The audio data security system of claim 8, wherein the supervisor module, based on the combined score, alerts a member of the information technology staff, drops a connection, logs a source and type of connection, and or blocks future connections from a source.

10. A method for providing audio data security, comprising:
receiving an audio communication stream; and
determining if the communication stream is valid.

11. The method of claim 10, wherein an analyzer determines if the communication stream is valid.

12. The method of claim 11, wherein the analyzer analyzes the audio communication stream for valid speech content, valid music content or valid speech content and valid music content.

13. The method of claim 10, further including decoding the audio communication stream to a common audio stream format.

14. The method of claim 12, wherein a data decoder decodes the audio communication stream into the common audio stream format.

15. The method of claim 14, wherein an analyzer analyzes the audio communication stream for valid speech content, valid music content or valid speech content and valid music content.

16. The method of claim 10, wherein the analyzer includes at least one member selected from the group consisting of a data encoding analyzer and a signal analyzer.

17. The method of claim 16, wherein the signal analyzer includes at least one member selected from the group consisting of a valid audio encoding detection module, a human speech frequency detection module, a human speech pattern detection module, a music frequency detection module, a human speech prosody detection module, a white noise detection module, an environmental noise detection module.

18. The method of claim 17, wherein the analyzer includes a supervisor module which combines scores from at least two modules.

19. The method of claim 18, wherein the supervisor module, based on the combined score, alerts a member of the information technology staff, drops a connection, logs a source and type of connection, and or blocks future connections from a source.

20. An audio data security system, comprising:
means for receiving an audio communication stream; and
means for analyzing the audio communication stream to determine if the communication stream is valid.
